(19) United States
(12) Patent Application Publication
(10) Pub. No.: US 2011/0039051 A1
(43) Pub. Date: Feb. 17, 2011

(54) FLOOR MAT

(76) Inventors: Willis E. Flowers, JR., Otto, NC (US); Scott Kimbrell, Hogansville, GA (US); Tim Montieth, Hogansville, GA (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/856,243

(22) Filed: Aug. 13, 2010

Related U.S. Application Data
(60) Provisional application No. 61/233,975, filed on Aug. 14, 2009.

(51) Int. Cl. B32B 3/02; D05B 23/00; D05B 1/00; B32B 27/00; B32B 3/30; B32B 37/16; B32B 38/00

(52) U.S. Cl. 428/78; 112/475.08; 112/154; 428/95; 156/244.19; 156/148; 156/148

(57) ABSTRACT

A floor mat and a method and apparatus for making a floor mat having desirable absorptive characteristics and constructed significantly of recycled or post industrial/consumer materials. A floor mat may be made of a base layer, a padding layer and a face layer. The base layer may comprise at least a portion of reprocessed rubber buffings formed to have an upper surface, a lower surface, and a plurality of nibs. The face layer may comprise a carper formed of at least a portion of which is post industrial and/or post consumer PET. The padding layer may be positioned between the base layer and the face layer comprising at least a portion of post industrial and/or post consumer PET. A method of manufacturing a floor mat may include the steps of mixing and heating recycled materials, such as recycled thermoplastic polyolefin elastomer, reprocessed rubber buffings, recycled low density polyethylene in an extruder, pushing the resulting molten material through a die at an exit end of the extruder; feeding the molten material along with a web of a facing layer and a padding layer through a nip, forming a matrix of cavities and/or nibs on a surface of the molten material, cooling the molten material to form a floor mat assembly incorporating the base material and the web, forming the floor mat assembly in a form die and cutting the floor mat assembly into individual floor mats in a cutting die.

### CROSS-REFERENCE TO RELATED APPLICATIONS

This application is related to provisional application Ser. No. 61/233,975 filed on Aug. 14, 2009 bearing the title “Floor Mat”. All disclosures in this prior application are incorporated by reference herein.

### TECHNICAL FIELD

This disclosure is related generally to carpeting and more particularly to absorptive floor mats for automotive environments.

### BACKGROUND

Floor mats for automotive applications are utilized in a demanding environment. They must be thin and not slide easily so as not to interfere with the operation of pedals by the driver of the vehicle. They must be sufficiently rugged to withstand the abuse of different types of shoes and different abrasive actions by these shoes when a driver is entering and leaving a vehicle as well as when a driver is operating the vehicle. They must endure various chemicals and debris brought in on the shoes of the driver as well as spilled by the driver onto the floor when the driver is in the vehicle. It is also desirable for them to absorb or otherwise manage noise from below the mat. In addition to the combination of durability, it is also desirable that floor mats have an attractive surface appearance. Like all automotive components, there is an increasing desire to manufacture floor mats in an environmentally friendly manner, such as by using recycled materials.

### BRIEF SUMMARY

A floor mat and a method and apparatus for making a floor mat having desirable absorptive characteristics and constructed significantly of recycled or post industrial/consumer materials are disclosed.

In one exemplary embodiment, a floor mat may be made of a base layer, a padding layer and a face layer. The base layer may comprise at least a portion of reprocessed rubber buffings formed to have an upper surface, a lower surface, and a plurality of nibs. The face layer may comprise a carpet formed of at least a portion of which is post industrial and/or post consumer PET. The padding layer may be positioned between the base layer and the face layer comprising at least a portion of post industrial and/or post consumer PET.

In another exemplary embodiment, a method of manufacturing a floor mat may include the steps of mixing and heating recycled materials, such as recycled thermoplastic polyolefin elastomer, reprocessed rubber buffings, recycled low density polyethylene in an extruder, pushing the resulting molten material through a die at an exit end of the extruder; feeding the molten material along with a web of a facing layer and a padding layer through a nip, forming a matrix of nibs on a surface of the molten material, cooling the molten material to form a floor mat assembly incorporating the base material and the web, forming the floor mat assembly in a form die and cutting the floor mat assembly into individual floor mats in a cutting die.

### BRIEF DESCRIPTION OF THE DRAWINGS

Some configurations of the energy management system will now be described, by way of example only and without disclaimer of other configurations, with reference to the accompanying drawings, in which:

FIG. 1 is a top plan view of an exemplary floor mat;

FIG. 2 is a partial bottom plan view of the floor mat of FIG. 1;

FIG. 3 is a sectional view of the floor mat of FIGS. 1 and 2 taken along line 3-3 of FIG. 2;

FIG. 4 is a top plan view similar to FIG. 5 of an alternative floor mat;

FIG. 5 is a top plan view of another alternative floor mat;

FIG. 6 is a partial bottom plan view of the floor mat of FIG. 5;

FIG. 7 is a sectional view of the floor mat of FIGS. 5 and 6 taken along line 6-6 of FIG. 6;

FIG. 8 is a top plan view of yet another alternative floor mat;

FIG. 9 is a partial bottom plan view of the floor mat of FIG. 8;

FIG. 10 is a sectional view of the floor mat of FIGS. 8 and 9 taken along line 10-10 of FIG. 9;

FIG. 11 is a block schematic of an assembly line for forming the floor mats of FIGS. 1-10; and

FIG. 12 is a flow chart of the method employed by the assembly line of FIG. 11.

### DETAILED DESCRIPTION OF THE DISCLOSURE

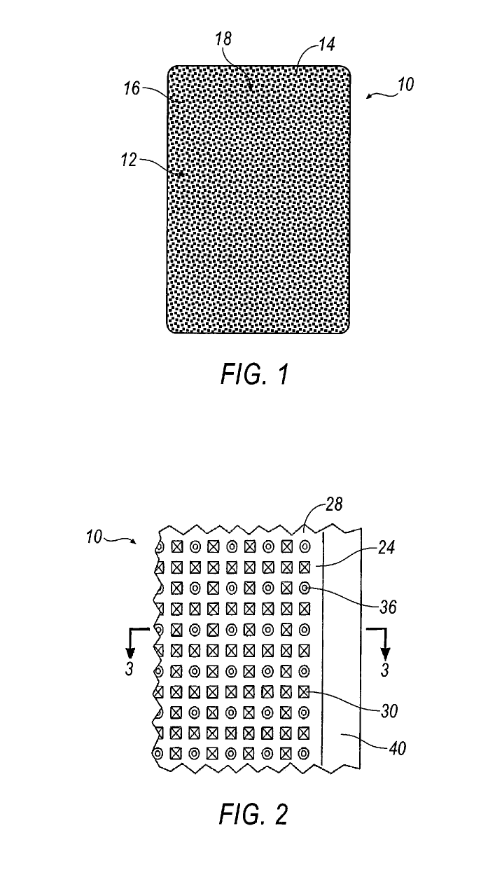

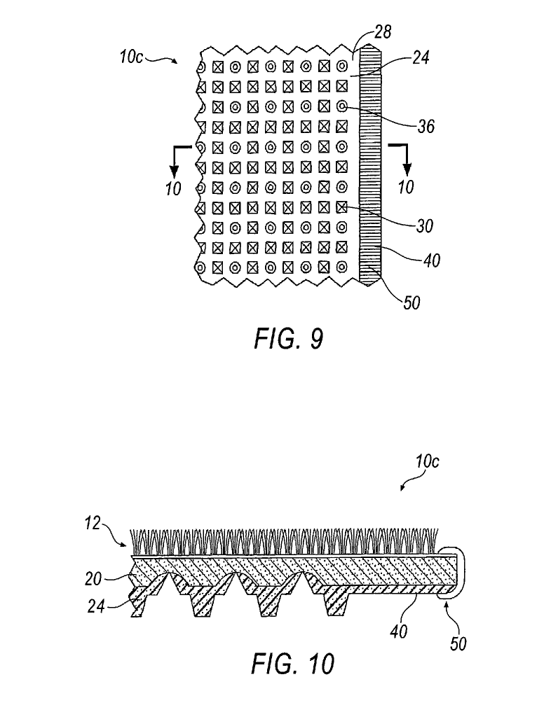

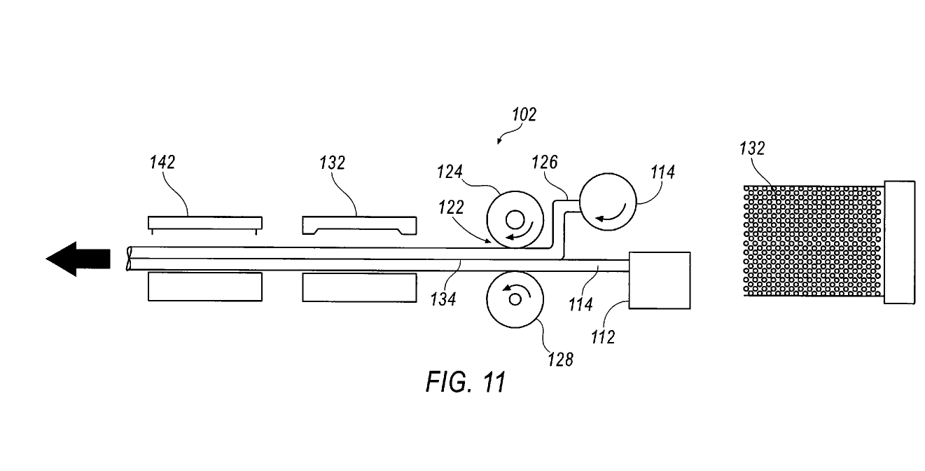

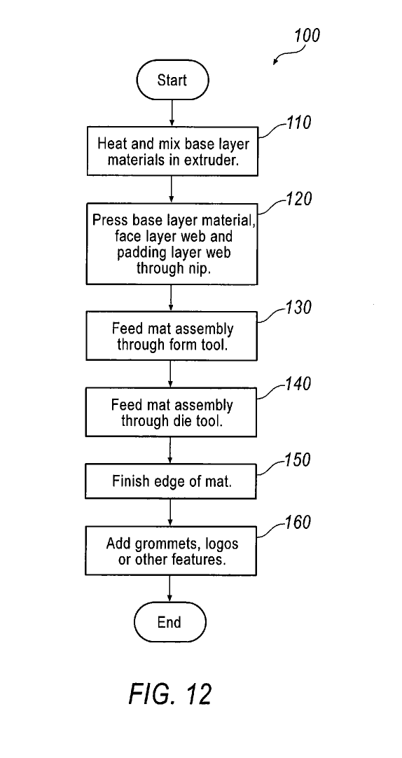

Referring now to the drawings wherein like reference numerals refer to like components throughout, exemplary floor mats will now be described with reference to FIGS. 1-10 and an exemplary method of manufacturing a floor mat will be described with reference to FIGS. 11 and 12. Although the drawings represent alternative configurations of floor mats and an exemplary method of manufacture thereof, the drawings are not necessarily to scale and certain features may be exaggerated to provide a better illustration and explanation of a configuration. The configurations set forth herein are not intended to be exhaustive or to otherwise limit the device to the precise forms disclosed in the following detailed description.

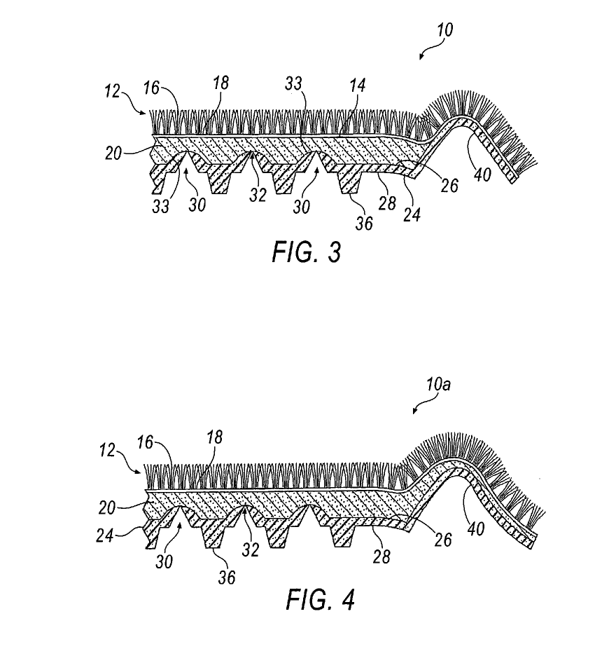

FIGS. 1-3 illustrate a first exemplary floor mat 10. As shown in FIG. 1, depicting the upper side floor mat 10, and in FIG. 3, depicting a section through floor mat 10, floor mat 10 includes a face layer 12 having an upper surface 14 comprising a carpet material with a plurality of tufts extending away from a backing, FIG. 3, to provide piles 16. Face layer 12 may be comprised of any durable material. For example, face layer 12 may comprise a needle punch material (e.g., needle punch carpet, needle punch felt or the like), woven fabric, porous material or the like. While a substantially continuous and substantially uniform face layer 12 is illustrated, other non-continuous and/or non-uniform face layers may be employed. For example, face layer 12 may be rendered non-continuous by adding a wear resistant surface, not shown, to a central portion of the floor mat. In one particular example, a rubber pad, not shown, may be added to provide increased wear resistance at locations that might experience increased traffic or increased force. A non-uniform face layer 12 may also be implemented to increase wear resistance, wherein a high-traffic area of floor mat 10 may include a higher density of piles 16 than a low-traffic area of floor mat 10.

As best shown in FIG. 3, face layer 12 may comprise a tufted carpet wherein a backing 18 locks a plurality of tufts in place; thereby creating a face surface with a plurality of piles 16. Backing 18 may comprise a porous mesh adapted to receive the tufts therein. Backing 18 may be made from PET or the like. Further, the PET may substantially or wholly include post industrial PET and/or post consumer PET. Post industrial PET is the PET waste generated by an industrial process involving PET (such as PET waste generated by a PET bottle making process), and post consumer PET is the PET obtained from recycled products, such as recycled PET bottles. The tufts may also be made from PET or the like, and approximately 40% of the PET used for the tufts may be post industrial/consumer PET, such as from recycled bottles. After tufting the tufts through the backing, a latex layer may then be applied to the rear surface of the backing to lock the tufts in place. Although many different materials may be applied to the rear surface of the backing to facilitate locking of the tufts, a latex precoat (e.g., FC423 latex precoat by Lile Industries) may provide a water resistant latex that is porous enough to allow transmission of air and acoustic waves while the pores are small enough to resist water leaks through face layer 12.

As shown in FIG. 3, floor mat 10 further includes a padding layer 20 underlying backing 18 of face layer 12. Padding layer 20 reduces manufacturing complications while enhancing the acoustic absorption properties of floor mat 10. While padding layer 10 is not necessary for carrying out many of the principles of the present invention, it may be utilized to enhance the acoustic absorption properties of floor mat 10. Padding layer 20 may also add desirable rigidity. Padding layer 20 may comprise a fibrous material, such as felt or the like, to enhance the acoustic energy absorption capabilities of floor mat 10. The choice of materials and thickness may be used to selectively “tune” the mat to optimize its acoustic absorption, reflection and transparency in use. For example, a fibrous material may be selected with a relatively small fiber size to enhance the acoustic absorption properties of the floor mat. One exemplary padding layer may comprise a felt layer including approximately 80%-90% post industrial and/or post consumer PET.

Padding layer 20 may comprise, for example, an 18+−2 ounce sized felt layer for an automotive floor mat. A layer of adhesive may be applied to one side of the padding layer to secure the padding layer to face layer 12. The adhesive may be a heat activated powder coat adhesive.

As shown in FIG. 2, depicting the lower side floor mat 10, and in FIG. 3, floor mat 10 further includes a base layer 24 underlying padding layer 20, shown only in FIG. 3. Base layer 24 has an upper surface 26, shown only in FIG. 3, affixed to padding layer 20 and a lower surface 28 for placement on a floor surface. Lower surface 28 incorporates one or more open-ended cavities 30 and nibs 36. As shown in FIG. 2, a plurality of cavities 30 formed in lower surface 28 may be arranged in a matrix format to optimize selective acoustic transmission through base layer 24. Structures formed when making cavities 30 may assist in providing a substantial barrier to the passage of liquid therethrough. As shown in FIG. 3, the thickness of the base layer 24 may advantageously be reduced at an upper surface of the cavities 30. As shown at 33, the thickness of padding layer 20 as well as the thickness of base layer 24 may be minimized near the apex 32 of at least one of the cavities 30. An aperture, such as a pin hole, not shown, may extend from near the apex 32 of the cavity 30 to the upper surface of the base layer 24.

The cavities 30 in base layer 24 may have a variety of shapes and configurations, including the shape of a pyramid with an apex. The cavities 30 may substantially define a four-sided pyramid-shaped cavity, FIG. 2, but may also define pyramid shapes with three or more sides. Alternatively, the cavities 30 may include other shapes such as a rectangular shaped cavity, a cube-shaped cavity, a cone-shaped cavity, frusto-conical shaped cavity, spherical-shaped cavity, cylindrical-shaped cavity or the like. The cavity shape may assist in one-way transmission of acoustic waves through the floor mat. For example, the cavity shape may function to funnel acoustic waves passing through the cavities down toward the floorboard while redirecting undesirable reflected acoustic waves away from the automobile interior and back toward the floorboard.

As further shown in FIGS. 2 and 3, one or a plurality of nibs 36 may extend downwardly from lower surface 28 of base layer 24 to provide a structural arrangement that may function to help anchor the floor mat on a support surface. Nibs 36 and cavities 30 may be arranged in a matrix of alternating nibs and cavities to facilitate acoustic penetration and anchor function throughout the footprint of the floor mat. The nibs 36 and cavities 30 may be arranged in rows and columns along a portion or substantially the entire footprint of the floor mat 10. As shown in FIG. 2, each nib 36 may be completely surrounded by eight adjacent cavities 30. This arrangement may provide beneficial acoustic properties while still providing a nib anchoring function. Nibs 36 and cavities 30 may be arranged in various alternative patterns such as providing nibs 36 only in certain locations of the mat to maximize the number of cavities 30 while still providing a network of nibs 36 to perform the anchoring function. Nibs 36 may also be provided at a greater concentration or entirely at the corners and/or along the periphery of floor mat 10.

Base layer 24 may be formed from a variety of materials. An exemplary base layer may include approximately 30%-40% of recycled thermoplastic polyolefin elastomer, approximately 40%-50% of reprocessed rubber buffings, such as from recycled tires, approximately 13%-23% of recycled low density polyethylene, and approximately 2% black color.

Padding layer 20 may be constructed so that it extends generally between base layer 24 and backing 18 of face layer 12. As shown in FIG. 3, padding layer 20 does not necessarily extend to the peripheral edge 40 of the floor mat. Rather, padding layer 20 extends between face layer 12 and base layer 20 in central portions of floor mat 10 without extending into the peripheral edge portion 40 of the mat. The cost of material may be reduced by providing a padding layer 20 with reduced dimensions so that it merely fits into the central portion of floor mat 10. In this configuration, padding layer 20 may still be effective to selectively absorb acoustic waves.

Alternatively, as shown in FIG. 4, an differently configured floor mat 10a may be manufactured having a padding layer 20 extending to the outermost portion of peripheral edge 40. Padding layer 20 may be thinner near peripheral edge 40, as shown in FIG. 4 or may be uniform in thickness throughout floor mat 10. It will be appreciated that providing each layer with essentially the same shape and size may simplify the manufacturing process and increase product uniformity by preventing the assembly worker from having to undergo a timely alignment process of the padding layer. Moreover, the manufacturing time may further be reduced by using the same die cutting mechanism for each layer.

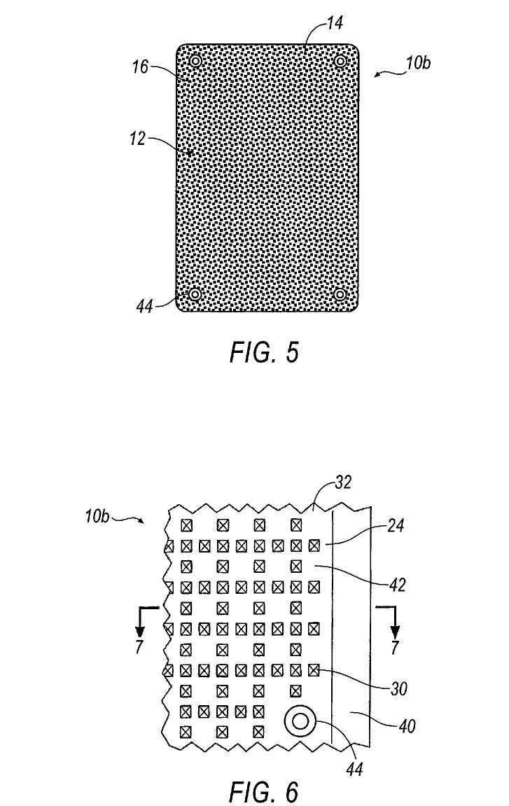

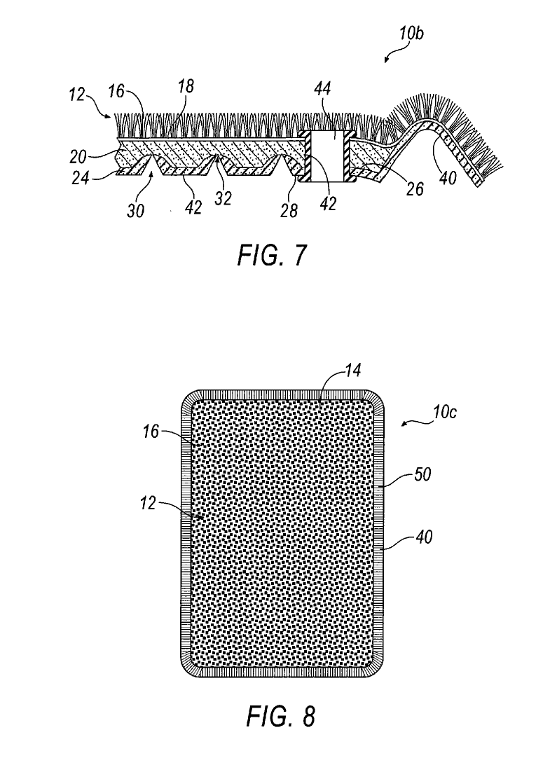

Referring to FIGS. 5-7, an alternative floor mat 10b is illustrated. Floor mat 10 may be similar to floor mat 10 or floor mat 10a described above except that lower surface 28 of floor mat 10b defines a matrix of open-ended cavities 30 without any nibs 36. This construction may enhance acoustic transmission through the base layer by maximizing the number of apertures and/or cavities in the lower surface. In this example, the frictional resistance to movement of floor mat 10a may be sufficient to anchor the mat in its desired location. Further, floor mat 10a may be anchored to a floor surface with one or more mechanical arrangements such as fasteners. In particular, the corners of floor mat 10b may include one or more apertures 42, shown only in FIG. 7, provided with grommets 44 adapted to receive a fastening device through the aperture to anchor the floor mat on a support surface.

Referring to FIGS. 8-10, another alternative floor mat 10c is illustrated. Floor mat 10c may be similar to floor mats 10, 10a or 10b described above except that the peripheral edge 40 is formed with a spiral hem 50, while floor mats 10, 10a, and 10b show a curved peripheral edge to provide a peripheral barrier to inhibit fluid flow from the mat to the surrounding support surface. A spiral hem 50 may be formed on the outer periphery to finish the final periphery of floor mat 10c, thereby preventing and/or discouraging separation of the layers at the periphery and providing an aesthetically pleasing floor mat.

While the floor mats illustrated in FIGS. 1, 10 are rectangular in shape, floor mats may comprise a variety of shapes depending on the anticipated use of the floor mats. For example, the floor mats 10, 10a, 10b and 10c may be circular, elliptical, a polygonal shape having three or more sides, or the like. Moreover, while the illustrated floor mats are generally planar, other three-dimensional shapes may be produced to easily conform with the curvature of the floor surface, such as an automotive floorboard, on which the floor mat is used.

Referring now to FIGS. 11 and 12, a method 100 for forming floor mat 10, 10a, 10b, 10c or 10d described above and an assembly line 102 for implementing method 100 are schematically illustrated. In the description which follows, the steps described are shown in FIG. 12 while the components described are depicted schematically in FIG. 11.

Method 100 for forming a floor mat begins in step 110 wherein base layer materials, such as recycled thermoplastic polyolefin elastomer, reprocessed rubber buffings, recycled low density polyethylene and black color, are mixed and heated in an extruder 112. The temperature at which the base layer materials are heated by extruder 112 may need to be adjusted to account for the inclusion of the reprocessed rubber buffings. For example, it has been found that the processing temperature may have to be increased by 15° F. when utilizing reprocessed rubber buffings in the base layer. Extruder 112 pushes the resulting molten material 114 through one or more dies at an exit end of the extruder.

In step 120, the molten material 114 then enters a nip 122 formed between a substantially smooth upper roller 124 and a lower roller 128. At the same time the molten material 114 enters nip 122, a web 126 comprising the face layer and the padding layer also enters nip 122. Nip 122 presses the molten material 114 onto the lower surface of the post industrial/consumer PET padding layer of web 126. Once the molten material 114 begins to cool, a melt bond is formed between the base layer and the padding layer. The outer surface of the lower roller 128 may include a matrix 132 of protrusions and/or cavities sufficient to provide the base layer with the desired structural features, such as nibs and cavities as the molten material 114 passes through the nip 122.

As the resulting mat assembly 134 exits nip 122, the mat assembly continues down the production line in step 130 to a form tool 132, which forms the floor mat in the mat assembly. Mat assembly 134 then continues in step 140 to a die tool 143 where individual floor mats are cut from the mat assembly 134.

Once cut into the desired shape, a serge edge (not shown) may be sewn in Step 150 along the peripheral edge of the shaped mat to give the edges of the mat a finished appearance. In Step 150, the sewn material may be sewn through the face layer, padding layer, and/or the base layer.

If a positive retention system is desired, the mat may continue further down the line in Step 160 to have grommets applied to the mat. In addition, any emblems, logos, or other markings may be added to the mat before final packaging.

It will be appreciated that the above described method provides a floor mat having desirable absorptive characteristics made substantially from recycled or post industrial/consumer materials.

With regard to the processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

It is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

Features shown or described in association with one configuration may be added to or used alternatively in another configuration, including configurations described or illustrated in the provisional patent application and the patent cooperation treaty patent application referred to in the above cross-reference to related applications. The scope of the device should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future configurations. In sum, it should be understood that the device is capable of modification and variation and is limited only by the following claims.

All terms are intended to be given their broadest reasonable constructions and their ordinary meanings as understood by those skilled in the art unless an explicit indication to the contrary in made herein. In particular, use of the singular articles such as “a” and “the,” should be read to recite one or more of the indicated elements unless a claim recites an explicit limitation to the contrary.

What is claimed as new and desired to be protected by Letters Patent of the United States is:

1. A floor mat comprising:
a) a base layer including an upper surface, a lower surface, and a plurality of cavities extending into the lower surface, the base layer being comprised of materials which include at least a portion of post industrial/consumer materials;
b) a face layer having an upper surface and a lower surface and comprising a carpet mounted adjacent the upper surface of the base layer, the face layer being comprised at least partially of post industrial/consumer materials; and
c) a padding layer positioned between the base layer and the face layer, the padding layer being comprised of post industrial/consumer materials.

2. A floor mat according to claim 1, wherein the post industrial/consumer materials of the base layer is selected from recycled thermoplastic polyolefin elastomer, reprocessed rubber buffings, and recycled low density polyethylene.

3. A floor mat according to claim 1, wherein the face layer is comprised of PET, at least a portion of which is post industrial and/or post consumer PET.

4. A floor mat according to claim 1, wherein the padding layer is comprised of PET, at least a portion of which is post industrial and/or post consumer PET.

5. A floor mat according to claim 1, wherein the padding layer further comprises indentations disposed adjacent the cavities in the base layer.

6. A floor mat according to claim 1, wherein the base layer, padding layer and face layer are the same dimensions and the padding layer substantially extends between the entire lower surface of the face layer and the entire upper surface of the base layer.

7. A floor mat according to claim 1, wherein the base layer and face layer are the same dimensions and the padding layer is smaller than the base and face layers, the padding layer being disposed between the middle region of the lower surface of the face layer and the upper surface of the base layer but not extending to the peripheral edges of the face and base layers.

9. A floor mat according to claim 1, further comprising a spiral hem sewing together peripheral edges of the base layer and the face layer.

10. A floor mat according to claim 1, further comprising a curved peripheral edge to provide a peripheral barrier to inhibit fluid flow from the mat to the surrounding support surface.

11. A floor mat according to claim 1, further comprising a plurality of nibs extending from the lower surface configured to reduce movement of the floor mat about a vehicle floor.

12. A floor mat according to claim 11, wherein said nibs and cavities are arranged in matrix wherein each nib is surrounded by a plurality of cavities.

13. A floor mat according to claim 11, wherein said nibs are positioned at predetermined locations to optimize the resistance of the mat to movement along its support surface.

14. A floor mat comprising:
a) a base layer including an upper surface, a lower surface, and a plurality of cavities extending into the lower surface and a plurality of nibs extending from the lower surface configured to reduce movement of the floor mat about a vehicle floor, the base layer being comprised of materials which include at least a portion of reprocessed rubber buffings;
b) a face layer having an upper surface and a lower surface and comprising a carpet mounted adjacent the upper surface of the base layer, the face layer being made of PET, at least a portion of which is post industrial and/or post consumer PET; and
c) a padding layer positioned between the base layer and the face layer, at least one surface of the padding layer having the shape of the respective protrusions, the padding layer made of PET, at least a portion of which is post industrial and/or post consumer PET.

15. A floor mat according to claim 14, wherein the base layer, padding layer and face layer are the same dimensions and the padding layer substantially extends between the entire lower surface of the face layer and the entire upper surface of the base layer.

16. A floor mat according to claim 14, wherein the base layer and face layer are the same dimensions and the padding layer is smaller than the base and face layers, the padding layer being disposed between the middle region of the lower surface of the face layer and the upper surface of the base layer but not extending to the peripheral edges of the face and base layers.

17. A floor mat according to claim 14, wherein said nibs are positioned at predetermined locations to optimize the resistance of the mat to movement along its support surface.

18. A method of manufacturing floor mats, said method comprising:
a) mixing and heating base layer materials comprising recycled materials in an extruder;
b) pushing the resulting molten mixture of base layer materials through a die at an exit end of the extruder;
c) feeding the molten material along with a web of a facing layer and a padding layer through a nip;
d) forming a matrix of cavities on a surface of the molten material;
e) cooling the molten material to form a floor mat assembly incorporating the base material and the web;
f) forming the floor mat assembly in a form die; and
g) cutting the floor mat assembly into individual floor mats in a cutting die.

19. A method according to claim 18, wherein the recycled materials used for the base layer are selected from recycled thermoplastic polyolefin elastomer, reprocessed rubber buffings, and recycled low density polyethylene.

20. A method according to claim 18, further comprising at least one of the steps of:
a) sewing a spiral hem on a peripheral edge of each floor mat;
b) punching at least one grommet through each floor mat; and
c) applying a marking to each floor mat.
